(19) United States
(12) Patent Application Publication
(10) Pub. No.: US 2004/0012265 A1
(43) Pub. Date: Jan. 22, 2004

(54) SYSTEM AND METHOD TO CONTROL REDUNDANT POWER SUPPLIES SELECTION

(75) Inventors: Jean-Francois Fauh, Vence (FR); Denis Roman, LaTurbie (FR)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/249,976

(22) Filed: May 23, 2003

(30) Foreign Application Priority Data
May 23, 2002 (FR) 02368054.9

(51) Int. Cl. H02J 7/00

(52) U.S. Cl. 307/64

(57) ABSTRACT

A system for controlling the connection of a receiving device to a main or a redundant power supply is provided. The system typically comprises a power supply voltage comparator, a reference voltage detector and a polarity detector to determine error voltage conditions from the main or from the redundant power supply. A decision circuit generates thereby a control signal to allow the connection of the receiver device to the appropriate power supply through the activation of a switch device.

### BACKGROUND OF INVENTION

The present invention relates to the field of power supply and more particularly to a system and method to control the selection of redundant power supplies.

In most of the data transmission systems, it is mandatory that the power sources supplying receiving devices be continuously active. Most of those systems commonly use redundant d.c. power sources to prevent any failure. If the active power source fails, the redundant one becomes active to maintain the system power supplied.

To switch from one source to the other, prior art redundant power supply circuits commonly use a forward biased diode per power source connected to the high and/or the low voltage potential lines. The diode avoids short circuits between the power sources and also protects the attached receiver against reversed polarity. However, because the output of each power source is routed through this pair of forward biased diodes useless power is lost. Moreover if one power source presents an overvoltage at its output terminals, this disturbance will impact the functioning of the receiving device or it may damage it.

Proposals have been made to remove this first drawback by replacing the forward biased diodes by relays or solid state switches. Generally, one switch per power source is connected to the receiver. A decision circuit which is able to sense which of the power sources presents the highest difference of potential between its terminals, enables the switch to close between the receiver and the sensed power source. Although such a configuration presents the advantage of being efficient in terms of power losses, significant problems remain, and particularly in the case of overvoltage of one power source, the receiver is still supplied by the faulty power supply. Moreover, if one of the switches fails to open, the receiver is no longer supplied.

Finally, if one component of the decision circuit or one of the switches fail, a short circuit between both power sources may happen.

Accordingly, there is a need in the technology for a system to selectively connect redundant power supplies which overcome the aforementioned problems of the prior art, and some other drawbacks.

### SUMMARY OF INVENTION

It is an object of the invention to provide a system and method to control the connection of a receiving device to redundant d.c. power supplies offering improved serviceability of the receiving device in case of failure.

It is another object of the invention to provide a system having a reverse polarity protection function which is effective in terms of power losses.

The present invention is directed towards a system for controlling the connection of a receiving device to a main power supply or to a redundant power supply comprising:

comparing means having a first input connected to the main power supply and a second input connected to the redundant power supply providing a status signal indicative of the highest power supply output voltage;

voltage detection means having a first input connected to the main power supply and a second input connected to the redundant power supply providing a main and a redundant detection signal indicative of error voltage conditions of the main and the redundant power supplies respectively; and

decision means coupled to the comparing means and to the voltage detection means providing a control signal in response to the status signal, the main detection signal and the redundant detection signal.

### BRIEF DESCRIPTION OF DRAWINGS

FIG. 1 is a block diagram of the system of the present invention.

FIG. 2 is a simplified schematic diagram of a preferred embodiment of the present invention.

FIGS. 3a and 3b is a simplified schematic diagram of a second embodiment of the present invention.

### DETAILED DESCRIPTION

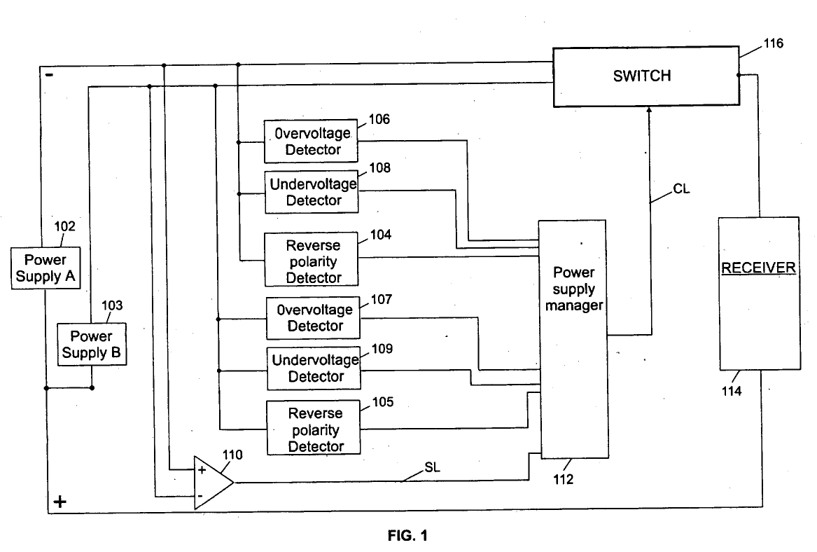

Referring first to FIG. 1, a preferred implementation of the system of the present invention to connect redundant power supplies (main power supply 102 and redundant power supply 103) to a receiver 114 is made of:

a main and a redundant polarity detectors (104,105). The input of the main polarity detector 104 is connected to the lower voltage output of the main power supply 102 thru a low voltage main line. Similarly, the input of the redundant polarity detector 105 is connected to the lower voltage output of the redundant power supply 103 thru a low voltage redundant line.

a main and a redundant overvoltage detectors (106,107). The input of the main overvoltage detector 106 is connected to the lower voltage output of the main power supply 102 thru the low voltage main line. Similarly, the input of the redundant overvoltage detector 107 is connected to the lower voltage output of the redundant power supply 103 thru the low voltage redundant line.

a main and a redundant undervoltage detectors (108,109). The input of the main undervoltage detector 108 is connected to the lower voltage output of the main power supply 102 thru the low voltage main line. Similarly, the input of the redundant undervoltage detector 109 is connected to the lower voltage output of the redundant power supply 103 thru the low voltage redundant line.

a comparator 110 having inputs connected to the lower voltage output of each power supply, and having an output connected to a power supply decision device 112.

a power supply decision device 112 having inputs connected to the output of each polarity detector, to the output of each overvoltage detector, to the output of each undervoltage detectors and to the output of the comparator. The decision device generates a control signal CL to control the selection of the main or the redundant power supply through a switching arrangement 116.

The switching arrangement 116 is not fully described as such implementations may be devised by those skilled in the art in a conventional manner. The switching arrangement enables establishment of a conductive path between the receiving device and the appropriate power supply by selectively turning on or off the main or the redundant switching arrangement according to the status of the control signal provided by the decision device.

The power supply decision circuit 112 may be implemented as a combinational logic circuitry which outputs two pairs of 2-bit logic levels (CL1,CL2) and (CL3,CL4). Each pair of 2-bit logic levels is the result of the combination of the outputs of the main overvoltage detector (respectively the redundant) with the main undervoltage detector (respectively the redundant) with the main polarity detector (respectively the redundant) and with comparator 110. It is to be appreciated by those skilled in the art that the principles used by the present invention are effective on various types of decision circuits such as programmable logic devices or micro-controller circuit as examples.

Comparator 110 outputs a status signal SL which indicates which of the main or of the redundant power supply presents the highest difference of potential between its output terminals.

In operation, a power supply that is connected in direct polarity, having an output voltage between its terminals comprised between a preset undervoltage threshold and a preset overvoltage threshold is said to be in a READY status. If one of the conditions is not fulfilled, the power supply is said to be in a FAULTY status.

A power supply that is READY and that presents the highest difference of potential between its output terminals is said to be in an ACTIVE status while the other remains READY, and the power supply decision circuit closes the switch in series between the ACTIVE power supply and the receiving device.

During operation, if the voltage between the output terminals of the ACTIVE power supply becomes lower than the voltage between the output terminals of the READY power supply, then the READY ones becomes ACTIVE and the ACTIVE ones returns to the READY status.

During operation, if the ACTIVE power supply becomes FAULTY, the READY ones becomes ACTIVE. But if the READY power supply becomes FAULTY, it can never be ACTIVE during this disturbance.

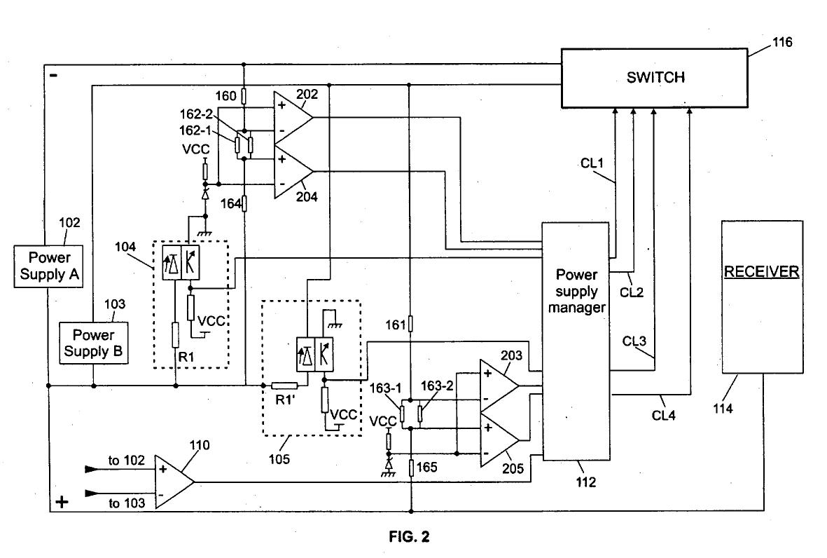

Referring now to FIG. 2, a more detailed description is made of the overvoltage detectors (106,107) and the undervoltage detectors (108,109) of the preferred embodiment of the invention. The main and the redundant overvoltage detectors are identical and mainly composed of an overvoltage comparator (202,203) and an overvoltage reference voltage.

The inverting input of each overvoltage comparator is connected to a voltage divider to receive a fraction of the difference of potential of the respective power supply. The voltage divider is conventional and made of several resistors (160,162-1,162-2,164 for comparator 202) and (161,163-1,163-2,165 for comparator 203). The non-inverting input of the overvoltage comparator is connected to the overvoltage reference. If the ratioed difference of potential is smaller than the overvoltage reference, the output of the comparator is set to a logical “one”, otherwise is set to “zero”.

The main and the redundant undervoltage detectors are identical and mainly composed of an undervoltage comparator (204,205) and an undervoltage reference voltage.

The non-inverting input of the undervoltage comparator is connected to a voltage divider to receive a second fraction of the difference of potential of the respective power supply. The voltage divider is preferably made of the same components as the voltage divider of the overvoltage comparator. The inverting input of the undervoltage comparator is connected to the undervoltage reference. If the ratioed difference of potential is higher than the undervoltage reference, the output of the undervoltage comparator is set to a logical ‘one’, otherwise the output is set to ‘zero’.

One skilled in the art will appreciate the safeness of this implementation w [symbol] the connection of the receiver to the active power supply is never interrup [symbol] nor damaged in the event of any single failure of either the overvoltage [symbol] detectors, the undervoltage detectors, the reverse polarity detectors or bo [symbol] power supplies as it is summarized in Table 1 below.

| | Status of Active | Backup | |
|---|---|---|---|
| Failure Category | Power Supply | Circuit | Comment |
| No Overvoltage detected | Overvoltage | None | Note 1 |
| by 106/107 | Not Overvoltage | No need | |
| No Undervoltage | Undervoltage | Comparator | Note 2 |
| detected by 108/109 | Not Undervoltage | No need | |
| No Reverse Polarity | Reverse polarity | OV Detector | Note 3 |
| detected by 104/105 | Not reversed | No need | |
| | polarity | | |
| Errouneous output of | N.A. | OV and UV | Note 4 |
| comparator 110 | | and RP | |
| | | detector | |
| Voltage reference | Any | OV detector | |
| shorted to ground | | | |
| Voltage reference | Any | UV detector | |
| shorted to supply voltage | | | |
| Resistor 160 or 161 | Any | OV Detector | |
| opened | | | |
| Resistor 160 or 161 | Any | UV Detector | |
| shorted | | | |
| Resistor 162-1 or 162-2 | Any | No need | Note 5 |
| or 163-1 or 163-2 | | | |
| opened | | | |
| Resistor 162-1 or 162-2 | Any | UV Detector | |
| or 163-1 or 163-2 | | | |
| shorted | | | |
| Resistor 164 or 165 | Any | UV Detector | |
| Opened | | | |
| Resistor 164 or 165 open | Any | OV Detector | |

Note 1: That case reflects a dual failure of the system.

Note 2: In such a case the power supply in Undervoltage is sensed as being the one having the lowest output voltage.

Note 3: In such a case the power supply in Reverse Polarity is sensed as being the one in Overvoltage.

Note 4: The receiver is supplied by one of the READY power supplies.

Note 5: The receiver is supplied by one of the main or the redundant power supplies without any risk because Overvoltage is detected, and Undervoltage is detected by comparator 110.

Advantage of the system according to the invention is that in all the aforementioned cases of failure, neither the power supplies nor the receiver are damaged. In any case of single failure and in most case of dual failure of both power supplies and of the input stage of the system, the receiver is supplied which positively impacts the serviceability of the receiver. Furthermore these errors may be reported.

It is to be appreciated that the logic to obtain the ACTIVE status of the power supplies may be reversed, and the requirements are the same but instead of selecting the power supply that presents the highest difference of potential between its terminals, the power supply that presents the lowest difference of potential between its terminals is selected. This is a preferred implementation in the case where the receiver device includes a voltage regulator or a DC to DC converter. In fact, for a given current consumption (Ic) and an output voltage (Vout) the power to be dissipated as heat in a voltage regulator is equal to (Vin−Vout)*Ic which clearly shows that the lower the Vin, the lower the power loss. Concerning a DC to DC converter, the efficiency strongly decreases when the input voltage increases. As an example, for an input voltage of 48V (which is a nominal value in telecommunication applications) the DC-DC efficiency ranges from 85% (48V) down to 80% (75V).

Some improvements to the system previously described may be designed [symbol] Particularly, a pair of comparators for sensing the voltage difference betw [symbol] the receiver terminal and the negative terminal of each power supply may [symbol] added. These comparators act as open circuit detectors to provide a warn [symbol] signal to the power supply decision circuit when the switch coupled to the [symbol] ACTIVE power supply is open. In such a case, the power supply decision [symbol] circuit opens (turns off) the defective switch and closes (turns on) the swit [symbol] coupled to the READY power supply, and the power supply associated wi [symbol] the faulty switch becomes FAULTY.

| | Status of Active | | |
|---|---|---|---|
| Failure Category | Sensed circuit | Backup Circuit | Comment |
| An open circuit of the | Open Circuit | None | Note 6 |
| switch is not detected | Not Open Circuit | None | Note 7 |
| One device of the | Not Applicable | Remaining | |
| switching arrangement | | Switch | |
| is open | | arrangement | |
| One device of the | Not Applicable | No need | Note 8 |
| switching arrangement | | | |
| is shorted | | | |

Note 6: To prevent such a failure, it is mandatory to implement a timer connected to the decision circuit in order that on each timer event if no power supply is faulty, a switch over is performed and the status of the switching arrangement is checked.

Note 7: The receiver is supplied by the other power supply.

Note 8: The receiver isn”t protected against reverse polarity, but this would be analyzed as a dual failure.

Another improvement to the preferred embodiment to prevent any short circuit of the power supplies, is to gate the switching arrangement by an inverted signal from the decision circuit. An inverter may be added at the corresponding main and redundant logical output of decision circuit 112.

To recall, the system according to the invention is robust against any single failure and against some other cases of dual failure of power supplies or of the system connecting them. As a consequence the serviceability of the receiver is improved.

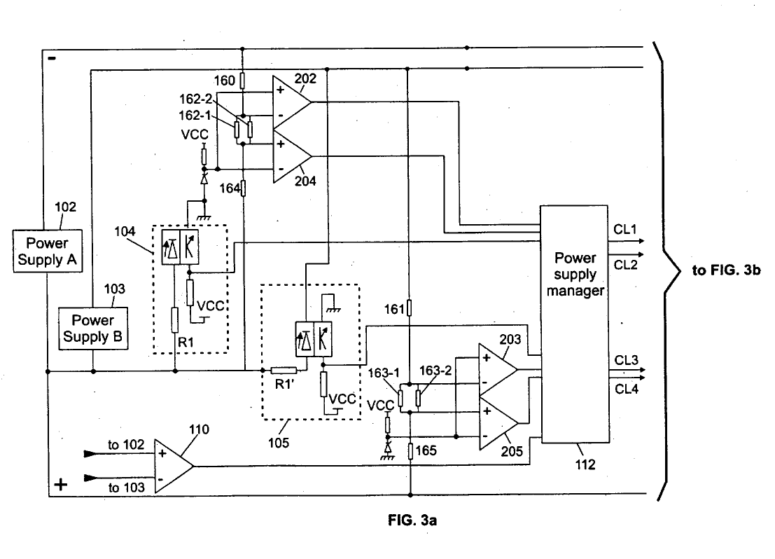

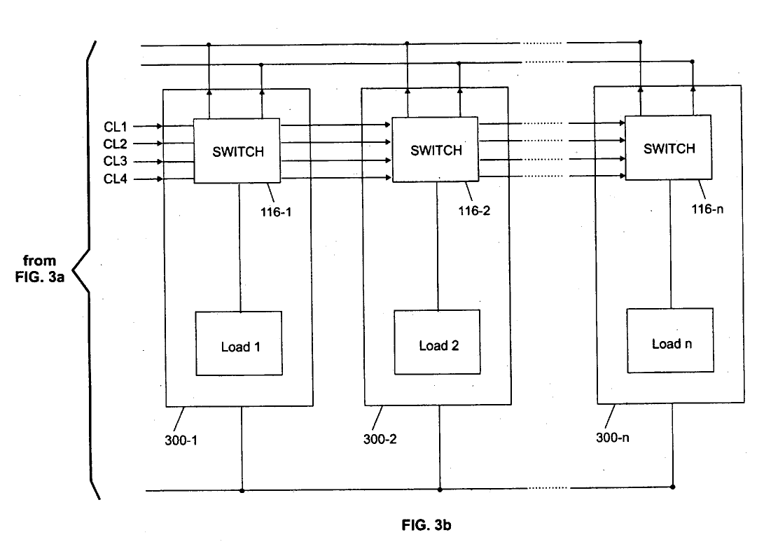

Another embodiment is shown on FIGS. 3a and 3b wherein the system of the invention operates for a plurality of receivers (300-1 to 300-n) having common power supply lines. Each receiver is composed of a switching arrangement (116-1 to 116-n) coupled to a load device (Load1 to Loadn). The control signals (CL1 to CL4) output from the decision circuit are fed to the switching circuit of each receiver. With this latter implementation, the system of the present invention is robust against common mode disturbances (such as ESD, EMI . . . ) that may occur.

Yet another embodiment is to implement pull-up and pull-down resistors on the control lines out of the supply decision circuit in order to offer a hot plugging of the controlling system of the invention, for example when a repair action is required while the receivers are still supplied.

1. A system for controlling the connection of a receiving device to a main power supply or to a redundant power supply comprising:
comparing means having a first input connected to the main power supply and a second input connected to the redundant power supply providing a status signal indicative of the highest power supply output voltage;
voltage detection means having a first input connected to the main power supply and a second input connected to the redundant power supply providing a main and a redundant detection signal indicative of error voltage conditions of the main and the redundant power supplies respectively; and
decision means coupled to the comparing means and to the voltage detection means providing a control signal in response to the status signal, the main detection signal and the redundant detection signal.

2. The system of claim 1 wherein the voltage detection means further comprises a threshold voltage detector for sensing a threshold condition of the outputs of the main and the redundant power supplies, and a polarity detector for sensing the polarity at the outputs of the main and the redundant power supplies.

3. The system of claim 2 wherein the threshold voltage detector further comprises an overvoltage detector for sensing if the outputs of the main and the redundant power supplies is above a preset overvoltage reference voltage.

4. The system of claim 2 wherein the threshold voltage detector further comprises an undervoltage detector for sensing if the outputs of the main and the redundant power supplies is below a preset undervoltage reference voltage.

5. The system of claim 2 wherein the threshold voltage detector further comprises a main threshold voltage detector coupled to the main power supply and a redundant threshold voltage detector coupled to the redundant power supply.

6. The system of claim 2 wherein the polarity detector further comprises a main polarity detector for sensing the polarity at the output of the main power supply and a redundant polarity detector for sensing the polarity at the output of the redundant power supply.

7. The system of claim 1 wherein the error voltage conditions comprise at least a reverse polarity condition indicative of a reverse polarity of the main or of the redundant power supply.

8. The system of claim 1 wherein the decision means further comprises means for providing a main control signal in response to the status signal combined with the main detection signal and a redundant control signal in response to the status signal combined with the redundant detection signal.

9. The system of claim 1 further comprising switching means coupled to both of the main and redundant power supplies and coupled to the receiving device for switching from the main to the redundant power supply or from the redundant to the main power supply in response to the control signal.

10. The system of claim 1 wherein the receiving means further comprises switching means coupled to both of the main and redundant power supplies and coupled to the decision means for switching from the main to the redundant power supply or from the redundant to the main power supply in response to the control signal.

11. The system of claim 10 further comprising a plurality of receiving means connected in parallel, each receiving means further comprising a respective switching means.

12. The system of claim 1 further comprising open circuit detection means coupled to the receiving device and the switching means to provide to the decision circuit an alarm signal indicative of an open circuit within the switching means.

13. The system of claim 3 wherein the main and the redundant overvoltage detectors are connected to a common overvoltage reference voltage.

14. The system of claim 13 wherein the overvoltage reference is equal to the receiver device maximum operating voltage.

15. The system of claim 6 wherein the main and the redundant undervoltage detectors are connected to a common undervoltage reference voltage.

16. The system of claim 15 wherein the undervoltage reference is equal to the receiver device minimum operating voltage.

17. The system of claim 3 wherein the threshold voltage detector further comprises an undervoltage detector for sensing if the outputs of the main and the redundant power supplies is below a preset undervoltage reference voltage.

18. The system of claim 17 wherein the threshold voltage detector further comprises a main threshold voltage detector coupled to the main power supply and a redundant threshold voltage detector coupled to the redundant power supply.

19. The system of claim 18 further comprising switching means coupled to both of the main and redundant power supplies and coupled to the receiving device for switching from the main to the redundant power supply or from the redundant to the main power supply in response to the control signal.

20. The system of claim 19 wherein the receiving means further comprises switching means coupled to both of the main and redundant power supplies and coupled to the decision means for switching from the main to the redundant power supply or from the redundant to the main power supply in response to the control signal.
